(19) United States
(12) Patent Application Publication
(10) Pub. No.: US 2025/0370582 A1
(43) Pub. Date: Dec. 4, 2025

(54) MEDIA CONTENT DISPLAY METHOD AND APPARATUS, ELECTRONIC DEVICE AND STORAGE MEDIUM

(71) Applicant: Beijing Zitiao Network Technology Co., Ltd., Beijing (CN)

(72) Inventors: Yuxuan ZHAO, Beijing (CN); Yang LIU, Beijing (CN)

(21) Appl. No.: 18/877,948

(22) PCT Filed: Nov. 24, 2023
(86) PCT No.: PCT/CN2023/133850

§ 371 Date: Dec. 20, 2024

(30) Foreign Application Priority Data
Nov. 29, 2022 (CN) 202211516589.1

(51) Int. Cl. G06F 3/0481; H04L 51/04

(52) U.S. Cl. CPC G06F 3/0481; H04L 51/04

(57) ABSTRACT

Embodiments of the present disclosure provide a media content display method and apparatus, an electronic device, and a storage medium. The media content display method includes: receiving a display operation, where the display operation is performed on target information in a first interface; in response to the display operation, displaying second media content in an image area of a second interface, and displaying a preset control for the second media content in a preset area of the second interface, where the second media content includes at least two segments of first media content, the at least two segments of first media content include the at least one piece of target first media content, the preset control includes a preset progress identifier corresponding to each piece of first media content, and the preset control is used for indicating a display progress of the second media content.

The present application claims priority to Chinese Patent Application No. 202211516589.1, filed on Nov. 29, 2022, which is incorporated herein by reference in its entirety as a part of the present application.

### TECHNICAL FIELD

Embodiments of the present disclosure relate to a media content display method and apparatus, an electronic device, and a storage medium.

### BACKGROUND

Currently, users may share viewed media content, such as videos or photo collections, in a chat and may view the media content shared in the chat. However, the display mode of the media content shared in the chat is relatively dull.

### SUMMARY

Embodiments of the present disclosure provide a media content display method and apparatus, an electronic device, and a storage medium, in order to diversify the display mode of media content in a chat.

According to a first aspect, an embodiment of the present disclosure provides a media content display method, which is applied to a target application. The method includes:
receiving a display operation of a first user, where the display operation is performed on target information in a first interface, the target information is associated with at least one piece of target first media content, the target information includes chat information between the first user and at least one second user in the target application, and the target application is an instant messaging application used for the first user to have a chat with the second user; and
in response to the display operation, displaying second media content in an image area of a second interface, and displaying a target control for the second media content in a preset area of the second interface, where the second media content includes at least two segments of first media content, the at least two segments of first media content include the at least one piece of target first media content, the target control includes a preset progress identifier corresponding to each piece of first media content, and the target control is used for indicating a display progress of the second media content.

According to a second aspect, an embodiment of the present disclosure further provides a media content display apparatus, which is configured in a target application. The apparatus includes: an operation receiving module configured to receive a display operation of a first user, where the display operation is performed on target information in a first interface, the target information is associated with at least one piece of target first media content, the target information includes chat information between the first user and at least one second user in the target application, and the target application is an instant messaging application used for the first user to have a chat with the second user; and a media content display module configured to, in response to the display operation, display second media content in an image area of a second interface, and display a target control for the second media content in a preset area of the second interface, where the second media content includes at least two segments of first media content, the at least two segments of first media content include the at least one piece of target first media content, the target control includes a preset progress identifier corresponding to each piece of first media content, and the target control is used for indicating a display progress of the second media content.

According to a third aspect, an embodiment of the present disclosure further provides an electronic device. The electronic device includes:
one or more processors; and
a memory configured to store one or more programs, where
the one or more programs, when executed by the one or more processors, cause the one or more processors to implement the media content display method as described in the embodiments of the present disclosure.

According to a fourth aspect, an embodiment of the present disclosure further provides a computer-readable storage medium having a computer program stored thereon, where when the program is executed by a processor, the media content display method as described in the embodiments of the present disclosure is implemented.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a media content display method according to an embodiment of the present disclosure;

FIG. 2 is a schematic diagram of display of a first interface according to an embodiment of the present disclosure;

FIG. 3 is a schematic diagram of display of a second interface according to an embodiment of the present disclosure;

FIG. 4 is a schematic flowchart of another media content display method according to an embodiment of the present disclosure;

FIG. 5 is a schematic diagram of display of another second interface according to an embodiment of the present disclosure;

FIG. 6 is a schematic diagram of display of still another second interface according to an embodiment of the present disclosure;

FIG. 7 is a block diagram of a structure of a media content display apparatus according to an embodiment of the present disclosure; and

FIG. 8 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the descriptions below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

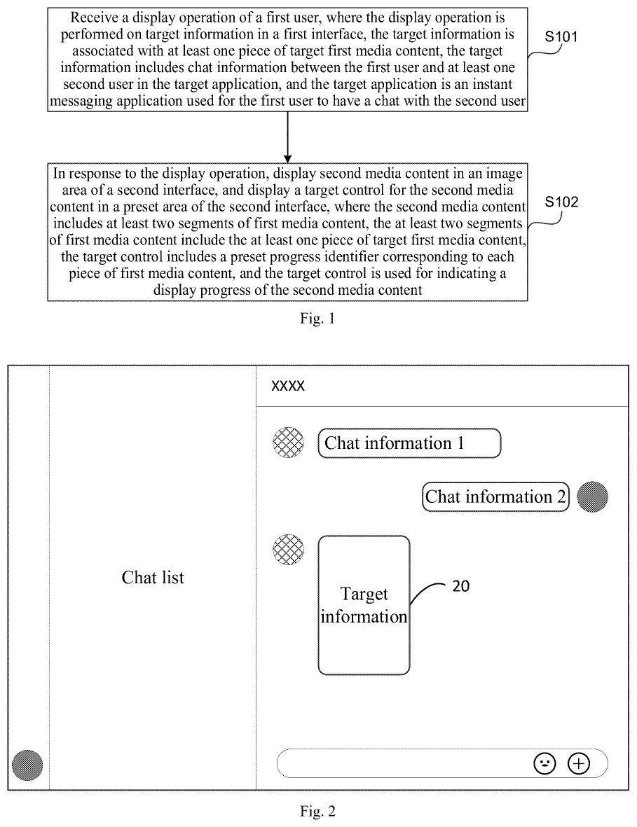

FIG. 1 is a schematic flowchart of a media content display method according to an embodiment of the present disclosure. The method may be performed by a media content display apparatus. The apparatus may be implemented by software and/or hardware, and may be configured in an electronic device, typically, in a computer. The media content display method provided in this embodiment of the present disclosure may be applied to a target application, and is suitable for use in a scenario of viewing media content shared in the target application in the form of chat information or work information. As shown in FIG. 1, the media content display method provided in this embodiment may include the following steps.

S101: Receive a display operation of a first user, where the display operation is performed on target information in a first interface, the target information is associated with at least one piece of target first media content, the target information includes chat information between the first user and at least one second user in the target application, and the target application is an instant messaging application used for the first user to have a chat with the second user.

The target application may be an application that performs the media content display method provided in this embodiment, and may be an instant messaging application, that is, an application for a user to perform instant messaging. The application may be used for the first user to have a chat with the second user. The first user may be understood as a current user, that is, a user who is currently performing the display operation, and may be any user in the target application. The second user may be a user other than the first user in the target application, such as a user who has a chat with the first user and/or a user who is in the same chat group as the first user. The first interface may be an information display interface in the target application, such as an interface for displaying the chat information and/or an interface for displaying activity information posted by friends.

The information display operation may be a trigger operation for indicating the display of media content corresponding to the target information, for example, an operation of triggering chat information or work information in the first interface that corresponds to the media content. The target information may be considered as information on which the information display operation is performed. The information is displayed in the first interface, and may have one or more pieces of corresponding media content. For example, when the first interface is a chat interface, the target information may be chat information of media content type in the first interface. When the first interface is an activity information display interface, the target information may be work information of the media content, for example, activity information of media content type. In this case, optionally, the target information further includes work information of the at least one piece of target first media content. The work information may include, for example, a title of the target first media content, poster information, and/or background music information in the media content. The poster information may be understood as information about a poster of the target first media content, such as an avatar and/or an alias of the poster of the target first media content.

The target first media content may be media content associated with the target information. The media content may be media content that has been posted in a preset application, such as video content, picture and text content, or picture content that has been posted in the preset application. Alternatively, the media content may be media content that has not been posted. The type of the target first media content is not limited in this embodiment. The picture and text content may be media content composed of at least one picture and text, such as media content in which a plurality of pictures are displayed in turn according to a preset sequence, and text is displayed on the pictures at the same time. The preset application and the target application may be the same or different applications. For example, the preset application and the target application may be applications on different types of terminals. For example, the preset application may be a media content application, such as a video application, that is used at a mobile client for a user to post and view media content. The target application may be an instant messaging application at a computer client.

In this embodiment, as shown in FIG. 2 (in which the first interface is a chat interface, for example), target information 20 associated with one or more pieces of target first media content may be displayed in the first interface. When the target information 20 is associated with one piece of target first media content, the target information 20 may include related information of the target first media content. When the target information 20 is associated with a plurality of pieces of target first media content, for example, when the target information 20 corresponds to a collection of media content, the target information 20 may include information related to at least one piece of target first media content. Herein, the related information may be information related to the target first media content, such as a cover of the target first media content, and may further include information such as a title of the target media content, poster information, and/or background music information in the target media content when the target first media content is posted media content. The cover of the target first media content may be, for example, a preset picture or a thumbnail of a video frame/picture in the target first media content.

For example, when viewing media content in the preset application, the user (such as the first user or the second user) may share the media content, in the form of chat information, to one or more chats of the user in the target application; or the user may share work information of the media content to the target application in the form of activity information, for example, share the work information of the media content as personal activity information of the user. The user may alternatively shoot one or more pieces of media content, and share the media content in the form of chat information/activity information.

As such, the user (such as the first user) in the chat may view the chat information/work information in the chat interface/on an activity information display page, and may perform a display operation on the media content, such as triggering the chat information/work information corresponding to the media content, when they want to view the media content.

Correspondingly, when detecting that a user triggers the chat information/work information, the target application may consider the user as the first user and determine that the display operation of the first user is received.

The activity information display page may be, for example, an activity information list page, such as a friends' circle page, for displaying activity information of different users; or the activity information display page may be a personal activity information page for displaying various pieces of activity information of a user, such as a personal activity information page of the user in the target application.

S102: In response to the display operation, display second media content in an image area of a second interface, and display a target control for the second media content in a preset area of the second interface, where the second media content includes at least two segments of first media content, the at least two segments of first media content include the at least one piece of target first media content, the target control includes a preset progress identifier corresponding to each piece of first media content, and the target control is used for indicating a display progress of the second media content.

The second interface may be an interface in the target application, and may be the same as or different from the first interface. The second interface may be used to display the target first media content corresponding to the target information triggered by the first user in the target application, such as to display the second media content including the target first media content. The image area may be an area in the second interface that is used to display an image of target media content, and an area ratio of the area may be preset; or the image area may be associated with an image ratio of the target first media content. For example, when an image aspect ratio of the target first media content is less than 1, the image area may be a preset area with an aspect ratio less than 1. When the image aspect ratio of the target first media content is greater than or equal to 1, the image area may be a preset area with an aspect ratio greater than or equal to 1. For example, the area ratio of the image area may be equal to the image ratio of the target media content.

The second media content may be media content including the target first media content. For example, the second media content may include the at least two segments of first media content. The at least two segments of first media content may include the at least one piece of target first media content associated with the target information, that is, each piece of target first media content may be included in the second media content as at least one segment of first media content in the second media content.

Optionally, the at least two segments of first media content further include another piece of first media content than the target first media content, and the another piece of first media content includes at least one of media content corresponding to information other than the target information in the first interface, media content having the same information sender as the target first media content, media content associated with the target first media content, and media content having the same poster as the target first media content.

The information sender may be a sender of information, that is, a user who sends corresponding information, and the user may be the first user or the second user.

For example, according to an arrangement sequence of each piece of information (including the target information) associated with media content in the first interface, media content associated with at least part of the information in the first interface may be aggregated to obtain the second media content, so that the first user views the media content associated with different information in the first interface; according to an arrangement sequence of each piece of information associated with media content in the first interface, media content associated with at least part of the information (including the target information) sent by a sender of the target information in the first interface may be aggregated to obtain the second media content, so that the first user views different media content shared by the information sender of the target information; at least part of the media content (including the target first media content) posted by the poster of the target first media content in the preset application may be aggregated to obtain the second media content, so that the first user views media content, other than the target first media content, that is posted by the poster of the target first media content; and/or the target first media content and the media content associated with the target first media content may be aggregated to obtain the second media content, so that the first user views the media content associated with the target first media content.

In this embodiment, when the second media content is obtained through aggregation of a plurality of pieces of media content, each piece of media content may exist in the second media content as at least one piece of first media content in the second media content. For example, for each piece of media content, if the media content includes a plurality of segments of media sub-content, for example, if the media content is media content of a second type and the media content includes a plurality of segments of media sub-content, each segment of media sub-content of the media content may be included in the second media content as a segment of first media content of the second type. If the media content does not include a plurality of segments of media sub-content, for example, if the media content is media content of a first type, or the media content is media content of a second type and the media content includes only one segment of media sub-content, the media content may be included in the second media content as a segment of first media content.

In some implementations, in this embodiment, when the second media content is obtained through aggregation of a plurality of pieces of media content, the media content does not need to be subjected to merging or splitting processing. In other words, in this embodiment, neither does media content data of the media content need to be merged into one piece of media content data, nor does each segment of media sub-content included in the media content need to be split into a plurality of pieces of independent media content.

The target control may be a control for indicating a display progress of the second media content. In the control, the preset progress identifier corresponding to each piece of first media content included in the second media content may be set. For example, in the target control, there may be one or more corresponding preset progress identifiers for each piece of first media content. The preset progress identifier may be used for indicating a display progress of corresponding first media content. The preset area may be understood as a display area for the target control in the second interface, i.e., an area in the second interface that is used for displaying the target control, which may or may not overlap with the first area.

Optionally, the target control includes one or more target components corresponding to the first media content, and the plurality of target components correspond to a plurality of segments of media sub-content included in the first media content, that is, when the first media content includes a plurality of segments of media sub-content, the first media content corresponds to the plurality of target components.

For example, for each segment of first media content (including the target first media content) in the second media content, when there is only one segment of media sub-content in the first media content, that is, when the first media content does not include a plurality of segments of media sub-content, the target control may include one target component corresponding to the first media content. When there are a plurality of segments of media sub-content in the first media content, the target control may include a plurality of target components corresponding to the first media content, for example, the target control may include target components corresponding to the media sub-content in the first media content on a one-to-one basis. The target component and the preset progress identifier may be the same or different components. For example, the target component may be the preset progress identifier or a control other than the preset progress identifier.

For another example, for each segment of first media content (including the target first media content) in the second media content, when the first media content is video content, the target control may include one target component corresponding to the first media content. When the first media content is picture and text content including one or more non-consecutive pictures, the target control may include target components corresponding to the pictures in the first media content on a one-to-one basis. Herein, the non-consecutive pictures may be understood as that the pictures are not consecutive video frames, that is, the pictures are not video frames captured by means of video recording.

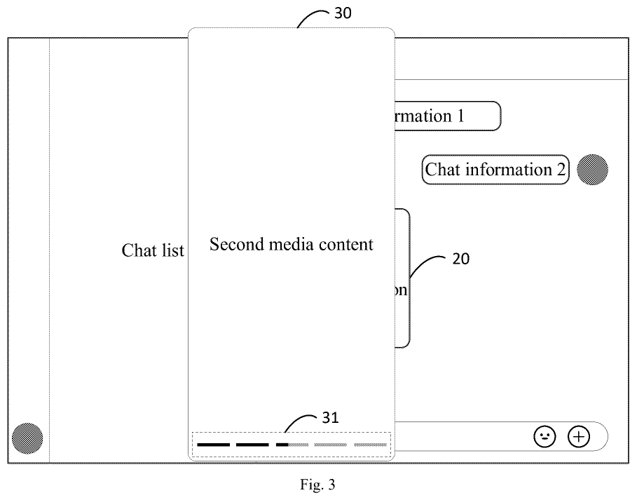

In this embodiment, when the display operation performed by the first user in the first interface is received, the second media content including the target first media content may be displayed in an image area 30 of the second interface in response to the display operation, the target control for the second media content may be displayed in a preset area 31 of the second interface, and the first interface keeps being displayed while the second interface is being displayed. For example, the first interface is displayed by covering the second interface, instead of closing the first interface, as shown in FIG. 3.

In this embodiment, the first interface and the second interface may be different interfaces, and a relative positional relationship between the first interface and the second interface may be adjusted, that is, the relative positional relationship between the second interface and the first interface is adjustable. For example, as required, the second interface may be adjusted to at least partially cover the first interface or not cover the first interface, or the second interface may be adjusted to be at least partially covered by the first interface, and so on. In this case, optionally, the media content display method provided in this embodiment further includes: adjusting the relative positional relationship between the first interface and the second interface in response to a position adjustment operation. The position adjustment operation may be a trigger operation for indicating adjustment of the relative positional relationship between the first interface and the second interface, such as a drag operation or a preset click operation for the second interface. The relative positional relationship may include, for example, a positional relationship between the first interface and the second interface within an image and/or a hierarchical relationship between a layer at which the first interface is located and a layer at which the second interface is located.

In this embodiment, when the second media content is displayed in the image area of the second interface, each piece of first media content in the second media content may be displayed in sequence in the image area with a start point of the second target media content as a display start point.

In this embodiment, when the second media content is displayed in the image area of the second interface, each piece of first media content in the second media content may alternatively be displayed in sequence in the image area with the target first media content as a display start point, such as with one piece of target first media content corresponding to the target information as the display start point, so that the first user views the target first media content corresponding to the target information. For example, each piece of first media content in the second media content may be displayed in sequence in the image area with a start point of one piece of target first media content or another time node as the display start point. In this case, optionally, displaying the second media content in the image area of the second interface includes: displaying, with the target first media content as the display start point, the first media content in the second media content in sequence in the image area of the second interface.

According to the media content display method provided in this embodiment, the display operation of the first user is received, where the display operation is performed on the target information in the first interface, the target information is associated with the at least one piece of target first media content, the target information includes the chat information between the first user and the at least one second user in the target application, and the target application is the instant messaging application used for the first user to have a chat with the second user; and in response to the display operation, the second media content is displayed in the image area of the second interface, and the target control for the second media content is displayed in the preset area of the second interface, where the second media content includes the at least two segments of first media content, the at least two segments of first media content include the at least one piece of target first media content, the target control includes the preset progress identifier corresponding to each piece of first media content, and the target control is used for indicating the display progress of the second media content. In this embodiment, with the above technical solution, the second media content including the first media content associated with the target information is displayed in response to the display operation on the target information, and the target control including the preset progress identifier corresponding to each piece of first media content is displayed, such that the display mode of media content can be diversified, and operations required for the user to view different media content can be simplified.

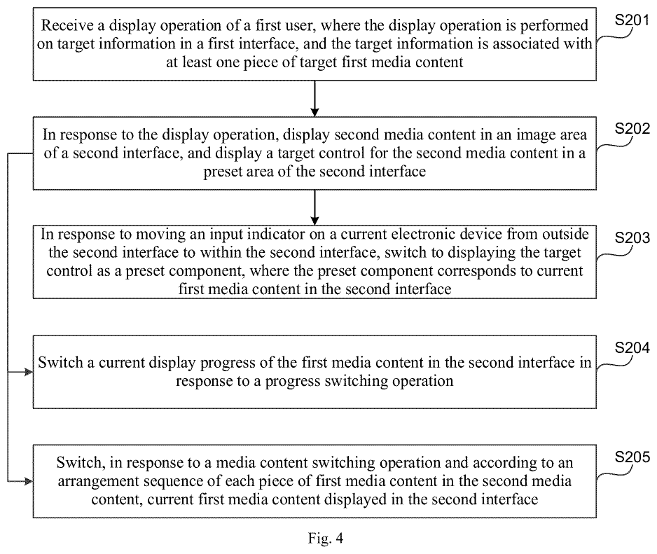

FIG. 4 is a schematic flowchart of another media content display method according to an embodiment of the present disclosure. The solution in this embodiment may be combined with one or more optional solutions in the above embodiment. Optionally, after the displaying second media content in a second interface, the method further includes: switching a current display progress of the first media content in the second interface in response to a progress switching operation; and/or switching, in response to a media content switching operation and according to an arrangement sequence of each piece of first media content in the second media content, current first media content displayed in the second interface, where the progress switching operation includes a trigger operation on a first key in a target keyboard; the media content switching operation includes at least one of a drag operation that is performed in a first area, a click operation that is performed in a second area, a trigger operation on a second key in the target keyboard, and a scroll operation on a mouse scroll wheel of a target mouse; and the first area and the second area are located in the image area, and the target keyboard and the target mouse have a communication connection established with a current electronic device.

Optionally, the media content display method provided in this embodiment further includes: in response to an input indicator on the current electronic device moving from outside the second interface to within the second interface, switching to displaying the target control as a preset component, where the preset component corresponds to the current first media content in the second interface, the preset component includes at least one of a progress control, a volume control, and a display control, and the progress control is used to drag to adjust the current display progress of the current first media content.

Correspondingly, as shown in FIG. 4, the media content display method provided in this embodiment may include the following steps.

S201: Receive a display operation of a first user, where the display operation is performed on target information in a first interface, the target information is associated with at least one piece of target first media content, the target information includes chat information between the first user and at least one second user in the target application, and the target application is an instant messaging application used for the first user to have a chat with the second user.

S202: In response to the display operation, display second media content in an image area of a second interface, display a target control for the second media content in a preset area of the second interface, and perform one or more of S203, S204, and S205, where the second media content includes at least two segments of first media content, the at least two segments of first media content include the at least one piece of target first media content, the target control includes a preset progress identifier corresponding to each piece of first media content, and the target control is used for indicating a display progress of the second media content.

S203: In response to an input indicator on the current electronic device moving from outside the second interface to within the second interface, switch to displaying the target control as a preset component, where the preset component corresponds to the current first media content in the second interface, the preset component includes at least one of a progress control, a volume control, and a display control, and the progress control is used to drag to adjust the current display progress of the current first media content.

The current electronic device may be an electronic device in which the target application is installed, such as an electronic device currently used by the first user. The input indicator may be considered as an indicator, such as a cursor, for indicating an input position on the current electronic device. The current first media content may be first media content currently displayed in the image area. The current display progress may be the current display progress of the current first media content.

The preset component may be a component corresponding to the current first media content, for example, a component for controlling the current first media content. The preset component may include at least one of the progress control, the volume control, and the display control.

The progress control may be used to drag to adjust the current display progress of the current first media content. For example, the progress control may include a progress identifier (such as a progress slider), so that the user may adjust the current display progress of the current first media content by dragging the progress identifier. The volume control may be a control for adjusting a volume of audio data in the current first media content.

The display control may be a control for indicating pausing/resuming display of the current first media content, and may include a display pause control for indicating switching of the current first media content from being displayed to being paused and/or a display resume control for indicating switching of the current first media content from being paused to being displayed. For example, when the current first media content is displayed and the input indicator on the current electronic device is located within the second interface, the display pause control for the current first media content may be displayed; or when the current first media content is paused and the input indicator on the current electronic device is located within the second interface, the display resume control for the current first media content may be displayed.

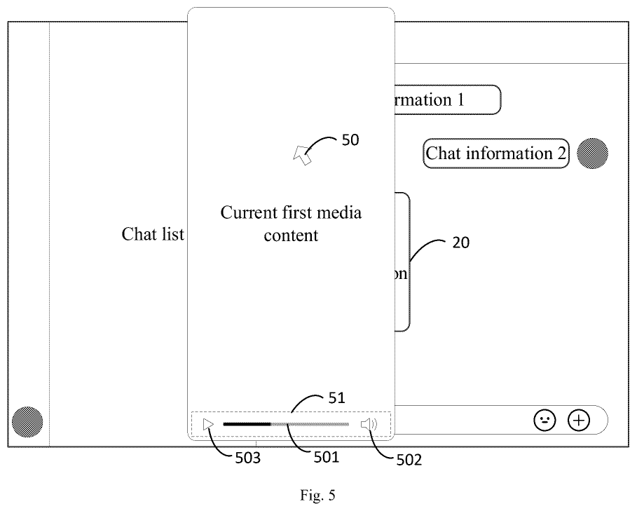

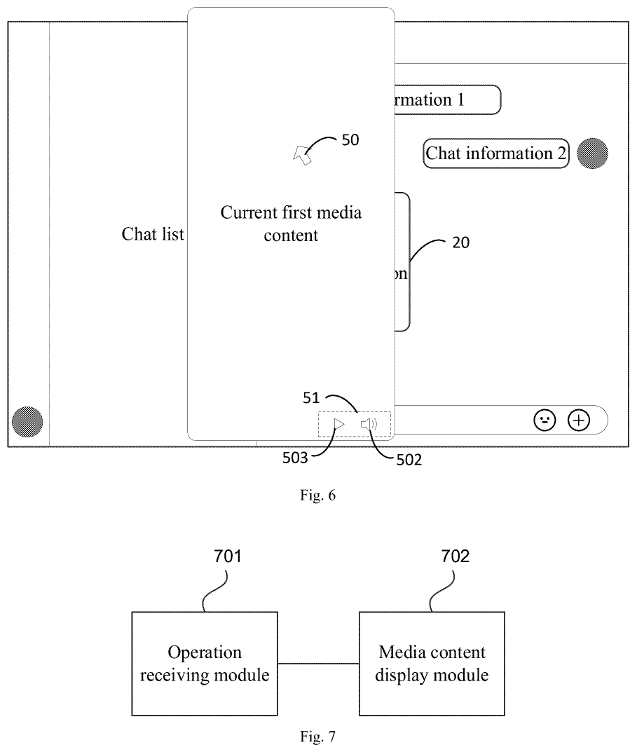

In this embodiment, when an input indicator 50 on the current electronic device moves from outside the second interface to within the second interface, the target control for the second media content may be switched to displaying as the preset component for the current media content, as shown in FIG. 5 and FIG. 6, until the input indicator 50 on the current electronic device moves out of the second interface, so that the first user controls the current first media content.

In some implementations, the switching to displaying the target control as a preset component includes: if the current first media content is media content of a first type, switching to displaying the target control as a first preset component, where the first preset component includes the progress control, the volume control, and the display control; and/or if the current first media content is media content of a second type, switching the target control to a second preset component, where the second preset component includes the volume control and the display control.

The first type and the second type may be different media content types. The first type and the second type are not limited in this embodiment. For example, the first type may be a video type, and the second type may be a picture and text type. The first preset component may be a preset component that includes a progress control, for example, the preset component that includes the progress control, the volume control, and the display control. The second preset component may be a preset component that does not include a progress control, for example, the preset component that includes only the volume control and the display control.

In the above implementation, different preset components may be displayed based on different types of the current first media content, making it possible to meet the needs of a user to view the current first media content and control the current first media content at the same time. It may be understood that the preset component may be displayed as a floating layer above a media content image, or may be displayed in an area other than the media content image in the second interface, such as in an area below the media content image, and is maintained at a fixed position relative to the media content image.

For example, when the current first media content is the media content of the first type, for example, when the current first media content is video content, a first preset component 51 corresponding to the current first media content may be displayed in the second interface when the input indicator 50 on the current electronic device is located within the second interface. For example, a progress control 501, a volume control 502, and a display control 503 corresponding to the current first media content are displayed, as shown in FIG. 5.

When the current first media content is the media content of the second type, for example, when the current first media content is picture and text content, a second preset component 52 corresponding to the current first media content may be displayed in the second interface when the input indicator 50 on the current electronic device is located within the second interface. For example, the volume control 502 and the display control 503 corresponding to the current media content are displayed, as shown in FIG. 6.

S204: Switch a current display progress of the first media content in the second interface in response to a progress switching operation, where the progress switching operation includes a trigger operation on a first key in a target keyboard, and the target keyboard has a communication connection established with the current electronic device.

The current display progress may be the current display progress of the current first media content. The progress switching operation may be a trigger operation for indicating switching of the current display progress of the current first media content displayed in the image area. For example, the progress switching operation may be a trigger operation on the first key in the target keyboard, such as an operation of clicking on the first key. The target keyboard may be a keyboard that has a communication connection established with the current electronic device. The first key may be a key in the target keyboard that is used for triggering execution of the progress switching operation, such as a left arrow key and a right arrow key in the target keyboard.

Specifically, when the progress switching operation is received, for example, when it is detected that the first user triggers a left arrow key/right arrow key in a first keyboard, the current display progress of target media content may be adjusted forward/backward by a preset duration. Herein, the preset duration may be set as required. For example, the preset duration may be set to a duration of 3 s, 5 s, etc.

In some implementations, the switching a current display progress of the first media content in the second interface includes: if the current first media content in the second interface is media content of a first type and a target duration of the current first media content is greater than a preset duration, switching the current display progress of the current first media content, where the target duration is a duration between the current display progress of the current first media content and a target endpoint of the current first media content, and the target endpoint is associated with the progress switching operation.

The target duration may be a duration between the current display progress of the current first media content and the target endpoint of the current first media content, that is, the duration between a time node to which the current first media content is currently displayed and the target endpoint of the current first media content. The target endpoint may be a start point or an end point of the current first media content. For example, when the progress switching operation is used for indicating switching of the current display progress of the current first media content forward, the target endpoint may be the start point of the current first media content. When the progress switching operation is used for indicating switching of the current display progress of the current first media content backward, the target endpoint may be the end point of the current first media content.

Specifically, when the current first media content in the second interface is the media content of the first type and the target duration of the current first media content is greater than the preset duration, the current display progress of the current first media content may be switched based on the received progress switching operation.

For example, if the currently received progress switching operation is used for indicating switching of the current display progress of the current first media content forward, the current first media content is video content, and the duration between the current display progress of the current first media content and the start point of the current first media content is greater than the preset duration, the current display progress of the current first media content may be adjusted forward by the preset duration in response to the progress switching operation.

If the currently received progress switching operation is used for indicating switching of the current display progress of the current first media content backward, the current first media content is video content, and the duration between the current display progress of the current first media content and the end point of the current first media content is greater than the preset duration, the current display progress of the current first media content may be adjusted backward by the preset duration in response to the progress switching operation.

In some implementations, the switching a current display progress of the first media content in the second interface further includes: if the current first media content in the second interface is media content of the first type and the target duration of the current first media content is less than or equal to the preset duration, or the current first media content is media content of a second type, switching the current first media content according to the arrangement sequence of each piece of first media content in the second media content.

Specifically, when the current first media content in the second interface is the media content of the first type and the target duration of the current first media content is less than or equal to the preset duration, or when the current first media content in the second interface is the media content of the second type, the current first media content displayed in the second interface may be switched based on the received progress switching operation.

For example, if the currently received progress switching operation is used for indicating switching of the current display progress of the current first media content forward, the current first media content is video content, and the duration between the current display progress of the current first media content and the start point of the current first media content is less than or equal to the preset duration, or if the currently received progress switching operation is used for indicating switching of the current display progress of the current first media content forward, and the current first media content is picture and text content, the current first media content may be switched to a previous piece of first media content in the second media content in response to the progress switching operation.

If the currently received progress switching operation is used for indicating switching of the current display progress of the current first media content backward, the current first media content is video content, and the duration between the current display progress of the current first media content and the end point of the current first media content is less than or equal to the preset duration, or if the currently received progress switching operation is used for indicating switching of the current display progress of the current first media content backward, and the current first media content is picture and text content, the current first media content may be switched to a next piece of first media content in the second media content in response to the progress switching operation.

S205: Switch, in response to a media content switching operation and according to an arrangement sequence of each piece of first media content in the second media content, current first media content displayed in the second interface, where the media content switching operation includes at least one of a drag operation that is performed in a first area, a click operation that is performed in a second area, a trigger operation on a second key in the target keyboard, and a scroll operation on a mouse scroll wheel of a target mouse; the first area and the second area are located in the image area, and the target keyboard and the target mouse have a communication connection established with the current electronic device.

The media content switching operation may be a trigger operation for indicating switching of current media content displayed in the first area. For example, the media content switching operation may include the drag operation that is performed in the first area, the click operation that is performed in the second area, the trigger operation on the second key in the target keyboard, and/or the scroll operation on the mouse scroll wheel of the target mouse.

The first area may be an area for dragging to perform the media content switching operation, and the second area may be an area for clicking to perform the media content switching operation. The first area and the second area may be located within the image area of the second interface. For example, the first area may be an area, other than the preset area and a position adjustment area, in the image area. The position adjustment area may be understood as an area for dragging to adjust a display position of the second interface in an image, such as a top area of the image area and/or a top area of the second interface. The second area may be a preset boundary area of the image area. The preset boundary area may be understood as an area located near a corresponding boundary of the image area, such as an area the distance of which from the corresponding boundary is less than a set distance. The preset boundary area may include, for example, a left boundary area or a right boundary area of the image area.

The second key may be a key in the target keyboard that is used for triggering execution of the media content switching operation, and the second key and the first key may be different keys in the target keyboard. For example, the first key may include a left arrow key and a right arrow key in the target keyboard, and the second key may include an up arrow key and a down arrow key in the target keyboard. The second key and the first key may alternatively be the same keys in the target keyboard, and in this case, the progress switching operation and the media content switching operation may correspond to different trigger modes. The target mouse may be a mouse with which the current electronic device has a communication connection established.

Specifically, when the media content switching operation is received, the current first media content displayed in the second interface may be switched based on the media content switching operation and the arrangement sequence of each piece of first media content in the second media content.

For example, when a right drag operation performed by the first user in the first area and a click operation performed by the first user in the left boundary area of the image area are detected, the up arrow key in the target keyboard is triggered by the first user, or the mouse scroll wheel is scrolled forward by the first user, the current media content may be switched to the previous piece of first media content in the second media content according to the arrangement sequence of each piece of first media content in the second media content. When a left drag operation performed by the first user in the first area and a click operation performed by the first user in the right boundary area of the image area are detected, the down arrow key in the target keyboard is triggered by the first user, or the mouse scroll wheel is scrolled backward by the first user, the current media content may be switched to the next piece of first media content in the second media content according to the arrangement sequence of each piece of first media content in the second media content.

According to the media content display method provided in this embodiment, on the premise of diversifying the display mode of media content, the display mode of the preset component corresponding to the current first media content and the control mode of the current first media content can be further diversified, and the operations required to switch the current display progress of the current first media content or switch the current first media content can be simplified.

FIG. 7 is a block diagram of a structure of a media content display apparatus according to an embodiment of the present disclosure. The apparatus may be implemented in software and/or hardware, and may be configured in a target application of an electronic device, typically in a target application of a computer. The apparatus may display media content shared, in the target application, in the form of chat information or work information by performing the media content display method. As shown in FIG. 7, the media content display apparatus provided in this embodiment may include: an operation receiving module 701 and a media content display module 702.

The operation receiving module 701 is configured to receive a display operation of a first user, where the display operation is performed on target information in a first interface, the target information is associated with at least one piece of target first media content, the target information includes chat information between the first user and at least one second user in the target application, and the target application is an instant messaging application used for the first user to have a chat with the second user.

The media content display module 702 is configured to, in response to the display operation, display second media content in an image area of a second interface, and display a target control for the second media content in a preset area of the second interface, where the second media content includes at least two segments of first media content, the at least two segments of first media content include the at least one piece of target first media content, the target control includes a preset progress identifier corresponding to each piece of first media content, and the target control is used for indicating a display progress of the second media content.

In the media content display apparatus provided in this embodiment, the operation receiving module receives the display operation of the first user, where the display operation is performed on the target information in the first interface, the target information is associated with the at least one piece of target first media content, the target information includes the chat information between the first user and the at least one second user in the target application, and the target application is the instant messaging application used for the first user to have a chat with the second user; and in response to the display operation, the media content display module displays the second media content in the image area of the second interface, and displays the target control for the second media content in the preset area of the second interface, where the second media content includes the at least two segments of first media content, the at least two segments of first media content include the at least one piece of target first media content, the target control includes the preset progress identifier corresponding to each piece of first media content, and the target control is used for indicating the display progress of the second media content. In this embodiment, with the above technical solution, the second media content including the first media content associated with the target information is displayed in response to the display operation on the target information, and the target control including the preset progress identifier corresponding to each piece of first media content is displayed, such that the display mode of media content can be diversified, and operations required for the user to view different media content can be simplified.

In the above solution, a relative positional relationship between the second interface and the first interface is adjustable.

In the above solution, the media content display module 702 may be configured to: display, with the target first media content as a display start point, the first media content in the second media content in sequence in the second interface.

Further, the media content display apparatus provided in this embodiment may further include: a progress switching module configured to, after the second media content is displayed in the image area of the second interface, switch a current display progress of the first media content in the second interface in response to a progress switching operation; and/or a media content switching module configured to, after the second media content is displayed in the image area of the second interface, switch, in response to a media content switching operation and according to an arrangement sequence of each piece of first media content in the second media content, current first media content displayed in the second interface, where the progress switching operation includes a trigger operation on a first key in a target keyboard; the media content switching operation includes at least one of a drag operation that is performed in a first area, a click operation that is performed in a second area, a trigger operation on a second key in the target keyboard, and a scroll operation on a mouse scroll wheel of a target mouse; and the first area and the second area are located in the image area, and the target keyboard and the target mouse have a communication connection established with a current electronic device.

In the above solution, the progress switching module may be configured to: in response to the current first media content in the second interface being media content of a first type and a target duration of the current first media content being greater than a preset duration, switch the current display progress of the current first media content, where the target duration is a duration between the current display progress of the current first media content and a target endpoint of the current first media content, and the target endpoint is associated with the progress switching operation.

In the above solution, the progress switching module may be further configured to: in response to the current first media content in the second interface being media content of the first type and the target duration of the current first media content being less than or equal to the preset duration, or the current first media content being media content of a second type, switch the current first media content according to the arrangement sequence of each piece of first media content in the second media content.

Further, the media content display apparatus provided in this embodiment may further include: a component display module configured to, in response to an input indicator on the current electronic device moving from outside the second interface to within the second interface, switch to displaying the target control as a preset component, where the preset component corresponds to the current first media content in the second interface, the preset component includes at least one of a progress control, a volume control, and a display control, and the progress control is used to drag to adjust the current display progress of the current first media content.

In the above solution, the component display module may be configured to: in response to the current first media content being the media content of the first type, switch to displaying the target control as a first preset component, where the first preset component includes the progress control, the volume control, and the display control; and/or in response to the current first media content being the media content of the second type, switch the target control to a second preset component, where the second preset component includes the volume control and the display control.

In the above solution, the at least two segments of first media content may further include another piece of first media content than the target first media content, and the another piece of first media content may include at least one of media content corresponding to information other than the target information in the first interface, media content having the same information sender as the target first media content, media content associated with the target first media content, and media content having the same poster as the target first media content.

In the above solution, the target control may include one or more target components corresponding to the first media content, and the plurality of target components may correspond to a plurality of segments of media sub-content contained in the first media content.

In the above solution, the target information may further include work information of the at least one piece of target first media content.

The media content display apparatus provided in this embodiment of the present disclosure may perform the media content display method according to any one of the embodiments of the present disclosure, and has corresponding functional modules and beneficial effects for performing the media content display method. For the technical details not described in detail in this embodiment, reference may be made to the media content display method provided in any embodiment of the present disclosure.

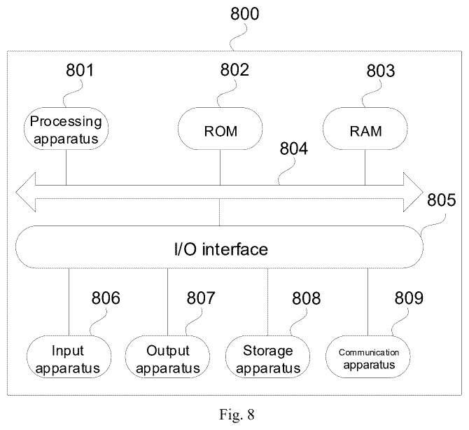

FIG. 8 is a schematic diagram of a structure of an electronic device (for example, a terminal device) 800 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (e.g., a central processing unit, a graphics processing unit, etc.) 801 that may perform a variety of appropriate actions and processing in accordance with a program stored in a read-only memory (ROM) 802 or a program loaded from a storage apparatus 808 into a random-access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it is not required to implement or have all the shown apparatuses. It may be an alternative to implement or have more or fewer apparatuses.

According to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 809, installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: receive a display operation of a first user, where the display operation is performed on target information in a first interface, the target information is associated with at least one piece of target first media content, the target information includes chat information between the first user and at least one second user in the target application, and the target application is an instant messaging application used for the first user to have a chat with the second user; and in response to the display operation, display second media content in an image area of a second interface, and display a target control for the second media content in a preset area of the second interface, where the second media content includes at least two segments of first media content, the at least two segments of first media content include the at least one piece of target first media content, the target control includes a preset progress identifier corresponding to each piece of first media content, and the target control is used for indicating a display progress of the second media content.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented in software or hardware. The name of a module does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) or a flash memory, an optic fiber, a portable compact disk read-only memory (CD-ROM), an optical storage device, a magnetic storage device, or any suitable combination thereof.

According to one or more embodiments of the present disclosure, Example 1 provides a media content display method, which is applied to a target application. The method includes:

receiving a display operation of a first user, where the display operation is performed on target information in a first interface, the target information is associated with at least one piece of target first media content, the target information includes chat information between the first user and at least one second user in the target application, and the target application is an instant messaging application used for the first user to have a chat with the second user; and
in response to the display operation, displaying second media content in an image area of a second interface, and displaying a target control for the second media content in a preset area of the second interface, where the second media content includes at least two segments of first media content, the at least two segments of first media content include the at least one piece of target first media content, the target control includes a preset progress identifier corresponding to each piece of first media content, and the target control is used for indicating a display progress of the second media content.

According to one or more embodiments of the present disclosure, Example 2 is based on the method of Example 1, where a relative positional relationship between the second interface and the first interface is adjustable.

According to one or more embodiments of the present disclosure, Example 3 is based on the method of Example 1, where the displaying second media content in an image area of a second interface includes: displaying, with the target first media content as a display start point, the first media content in the second media content in sequence in the second interface.

According to one or more embodiments of the present disclosure, Example 4 is based on the method of Example 1, where after the displaying second media content in an image area of a second interface, the method further includes:

switching a current display progress of the first media content in the second interface in response to a progress switching operation; and/or
switching, in response to a media content switching operation and according to an arrangement sequence of each piece of first media content in the second media content, current first media content displayed in the second interface,
where the progress switching operation includes a trigger operation on a first key in a target keyboard; the media content switching operation includes at least one of a drag operation that is performed in a first area, a click operation that is performed in a second area, a trigger operation on a second key in the target keyboard, and a scroll operation on a mouse scroll wheel of a target mouse; and the first area and the second area are located in the image area, and the target keyboard and the target mouse have a communication connection established with a current electronic device.

According to one or more embodiments of the present disclosure, Example 5 is based on the method of Example 4, where the switching a current display progress of the first media content in the second interface includes:

if the current first media content in the second interface is media content of a first type and a target duration of the current first media content is greater than a preset duration, switching the current display progress of the current first media content, where the target duration is a duration between the current display progress of the current first media content and a target endpoint of the current first media content, and the target endpoint is associated with the progress switching operation.

According to one or more embodiments of the present disclosure, Example 6 is based on the method of Example 5, where the switching a current display progress of the first media content in the second interface further includes:

if the current first media content in the second interface is media content of the first type and the target duration of the current first media content is less than or equal to the preset duration, or the current first media content is media content of a second type, switching the current first media content according to the arrangement sequence of each piece of first media content in the second media content.

According to one or more embodiments of the present disclosure, Example 7 is based on the method of Example 1, where the method further includes:

in response to an input indicator on the current electronic device moving from outside the second interface to within the second interface, switching to displaying the target control as a preset component, where the preset component corresponds to the current first media content in the second interface, the preset component includes at least one of a progress control, a volume control, and a display control, and the progress control is used to drag to adjust the current display progress of the current first media content.

According to one or more embodiments of the present disclosure, Example 8 is based on the method of Example 7, where the switching to displaying the target control as a preset component includes: if the current first media content is media content of a first type, switching to displaying the target control as a first preset component, where the first preset component includes the progress control, the volume control, and the display control; and/or

if the current first media content is media content of a second type, switching the target control to a second preset component, where the second preset component includes the volume control and the display control.

According to one or more embodiments of the present disclosure, Example 9 is based on the method of any one of Examples 1 to 8, where the at least two segments of first media content further include another piece of first media content than the target first media content, and the another piece of first media content includes at least one of media content corresponding to information other than the target information in the first interface, media content having the same information sender as the target first media content, media content associated with the target first media content, and media content having the same poster as the target first media content.

According to one or more embodiments of the present disclosure, Example 10 is based on the method of any one of Examples 1 to 8, where the target control includes one or more target components corresponding to the first media content, and the plurality of target components correspond to a plurality of segments of media sub-content contained in the first media content.

According to one or more embodiments of the present disclosure, Example 11 is based on the method of any one of Examples 1 to 8, where the target information further includes work information of the at least one piece of target first media content.

According to one or more embodiments of the present disclosure, Example 12 provides a media content display apparatus, which is configured in a target application. The apparatus includes:

an operation receiving module configured to receive a display operation of a first user, where the display operation is performed on target information in a first interface, the target information is associated with at least one piece of target first media content, the target information includes chat information between the first user and at least one second user in the target application, and the target application is an instant messaging application used for the first user to have a chat with the second user; and
a media content display module configured to, in response to the display operation, display second media content in an image area of a second interface, and display a target control for the second media content in a preset area of the second interface, where the second media content includes at least two segments of first media content, the at least two segments of first media content include the at least one piece of target first media content, the target control includes a preset progress identifier corresponding to each piece of first media content, and the target control is used for indicating a display progress of the second media content.

According to one or more embodiments of the present disclosure, Example 13 provides an electronic device. The electronic device includes:

one or more processors; and
a memory configured to store one or more programs, where
the one or more programs, when executed by the one or more processors, cause the one or more processors to implement the media content display method according to any one of Examples 1 to 11.

According to one or more embodiments of the present disclosure, Example 14 provides a computer-readable storage medium having a computer program stored thereon, where the computer program, when executed by a processor, causes the media content display method according to any one of Examples 1 to 11 to be implemented.

The foregoing descriptions are merely embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A media content display method, which is applied to a preset application of a first user, the method comprising:
receiving a display operation, wherein the display operation is performed on target information in a first interface, the target information is associated with at least one piece of target first media content, the target information comprises chat information between the first user and at least one second user in the preset application, and the preset application is an instant messaging application used for the first user to have a chat with the second user; and
in response to the display operation, displaying second media content in an image area of a second interface, and displaying a preset control for the second media content in a preset area of the second interface, wherein the second media content comprises at least two segments of first media content, the at least two segments of first media content comprise the at least one piece of target first media content, the preset control comprises a preset progress identifier corresponding to each piece of first media content, and the preset control is configured for indicating a display progress of the second media content.

2. The method according to claim 1, wherein a relative positional relationship between the second interface and the first interface is adjustable.

3. The method according to claim 1, wherein the displaying second media content in an image area of a second interface comprises:
displaying, with the target first media content as a display start point, the first media content in the second media content in sequence in the second interface.

4. The method according to claim 1, wherein after the displaying second media content in an image area of a second interface, the method further comprises at least one of the following:
switching a current display progress of the first media content in the second interface in response to a progress switching operation, wherein the progress switching operation comprises a trigger operation on a first key in a target keyboard;
switching, in response to a media content switching operation and according to an arrangement sequence of each piece of first media content in the second media content, current first media content displayed in the second interface, the media content switching operation comprises at least one of a drag operation that is performed in a first area, a click operation that is performed in a second area, a trigger operation on a second key in the target keyboard, and a scroll operation on a mouse scroll wheel of a target mouse; and the first area and the second area are located in the image area, and the target keyboard and the target mouse have a communication connection established with a current electronic device.

5. The method according to claim 4, wherein the switching a current display progress of the first media content in the second interface comprises:
in response to the current first media content in the second interface being media content of a first type and a target duration of the current first media content is greater than a preset duration, switching the current display progress of the current first media content, wherein the target duration is a duration between the current display progress of the current first media content and a target endpoint of the current first media content, and the target endpoint is associated with the progress switching operation.

6. The method according to claim 5, wherein the switching a current display progress of the first media content in the second interface further comprises:
in response to the current first media content in the second interface being media content of the first type and the target duration of the current first media content is less than or equal to the preset duration, or the current first media content is media content of a second type, switching the current first media content according to the arrangement sequence of each piece of first media content in the second media content.

7. The method according to claim 1, further comprising:
in response to an input indicator on the current electronic device moving from outside the second interface to within the second interface, switching to displaying the preset control as a preset component, wherein the preset component corresponds to the current first media content in the second interface, the preset component comprises at least one of a progress control, a volume control, and a display control, and the progress control is used to drag to adjust the current display progress of the current first media content.

8. The method according to claim 7, wherein the switching to displaying the preset control as a preset component comprises at least one of the following:
in response to the current first media content being the media content of the first type, switching to displaying the preset control as a first preset component, wherein the first preset component comprises the progress control, the volume control, and the display control;
in response to the current first media content being the media content of the second type, switching the preset control to a second preset component, wherein the second preset component comprises the volume control and the display control.

9. The method according to claim 1, wherein the at least two segments of first media content further comprise another piece of first media content than the target first media content, and the another piece of first media content comprises at least one of media content corresponding to information other than the target information in the first interface, media content having the same information sender as the target first media content, media content associated with the target first media content, and media content having the same poster as the target first media content.

10. The method according to claim 1, wherein the preset control comprises one or more target components corresponding to the first media content, and the plurality of target components correspond to a plurality of segments of media sub-content contained in the first media content.

11. The method according to claim 1, wherein the target information further comprises work information of the at least one piece of target first media content.

12. (canceled)

13. An electronic device, comprising:
at least one processor; and
a memory communicatively connected to the at least one processor, wherein
the memory stores a computer program executable by the at least one processor, and the computer program, when executed by the at least one processor, causes the at least one processor to perform a media content display method, the method is applied to a preset application of a first user, and the method comprises:
receiving a display operation, wherein the display operation is performed on target information in a first interface, the target information is associated with at least one piece of target first media content, the target information comprises chat information between the first user and at least one second user in the preset application, and the preset application is an instant messaging application used for the first user to have a chat with the second user; and
in response to the display operation, displaying second media content in an image area of a second interface, and displaying a preset control for the second media content in a preset area of the second interface, wherein the second media content comprises at least two segments of first media content, the at least two segments of first media content comprise the at least one piece of target first media content, the preset control comprises a preset progress identifier corresponding to each piece of first media content, and the preset control is used for indicating a display progress of the second media content.

14. A non-transitory computer-readable storage medium, storing computer instructions that, when executed by a processor, cause a media content display method to be implemented, the method is applied to a preset application of a first user, and the method comprises:
receiving a display operation, wherein the display operation is performed on target information in a first interface, the target information is associated with at least one piece of target first media content, the target information comprises chat information between the first user and at least one second user in the preset application, and the preset application is an instant messaging application used for the first user to have a chat with the second user; and
in response to the display operation, displaying second media content in an image area of a second interface, and displaying a preset control for the second media content in a preset area of the second interface, wherein the second media content comprises at least two segments of first media content, the at least two segments of first media content comprise the at least one piece of target first media content, the preset control comprises a preset progress identifier corresponding to each piece of first media content, and the preset control is used for indicating a display progress of the second media content.

15. The electronic device according to claim 13, wherein a relative positional relationship between the second interface and the first interface is adjustable.

16. The electronic device according to claim 13, wherein the displaying second media content in an image area of a second interface comprises:
displaying, with the target first media content as a display start point, the first media content in the second media content in sequence in the second interface.

17. The electronic device according to claim 13, wherein after the displaying second media content in an image area of a second interface, the method further comprises:
switching a current display progress of the first media content in the second interface in response to a progress switching operation; and/or
switching, in response to a media content switching operation and according to an arrangement sequence of each piece of first media content in the second media content, current first media content displayed in the second interface,
wherein the progress switching operation comprises a trigger operation on a first key in a target keyboard; the media content switching operation comprises at least one of a drag operation that is performed in a first area, a click operation that is performed in a second area, a trigger operation on a second key in the target keyboard, and a scroll operation on a mouse scroll wheel of a target mouse; and the first area and the second area are located in the image area, and the target keyboard and the target mouse have a communication connection established with a current electronic device.

18. The electronic device according to claim 17, wherein the switching a current display progress of the first media content in the second interface comprises:
in response to the current first media content in the second interface being media content of a first type and a target duration of the current first media content is greater than a preset duration, switching the current display progress of the current first media content, wherein the target duration is a duration between the current display progress of the current first media content and a target endpoint of the current first media content, and the target endpoint is associated with the progress switching operation.

19. The electronic device according to claim 18, wherein the switching a current display progress of the first media content in the second interface further comprises:
in response to the current first media content in the second interface being media content of the first type and the target duration of the current first media content is less than or equal to the preset duration, or the current first media content is media content of a second type, switching the current first media content according to the arrangement sequence of each piece of first media content in the second media content.

20. The electronic device according to claim 13, wherein the method further comprising:
in response to an input indicator on the current electronic device moving from outside the second interface to within the second interface, switching to displaying the preset control as a preset component, wherein the preset component corresponds to the current first media content in the second interface, the preset component comprises at least one of a progress control, a volume control, and a display control, and the progress control is used to drag to adjust the current display progress of the current first media content.

21. The electronic device according to claim 20, wherein the switching to displaying the preset control as a preset component comprises at least one of the following:
in response to the current first media content being the media content of the first type, switching to displaying the preset control as a first preset component, wherein the first preset component comprises the progress control, the volume control, and the display control;
in response to the current first media content being the media content of the second type, switching the preset control to a second preset component, wherein the second preset component comprises the volume control and the display control.
